(19) United States
(12) Patent Application Publication
(10) Pub. No.: US 2012/0254962 A1
(43) Pub. Date: Oct. 4, 2012

(54) MANAGEMENT SYSTEM, A MANAGEMENT PROCESS, AND A QUICK ACCESS METHOD OF INFORMATION CONTENT FOR A DIGITAL NETWORKING DEVICE

(76) Inventor: Hung-Ting CHEN, (US)

(21) Appl. No.: 13/116,619

(22) Filed: May 26, 2011

(30) Foreign Application Priority Data
Mar. 31, 2011 (CN) 201110080677.7

(51) Int. Cl. H04L 9/32; G06F 21/00

(52) U.S. Cl. 726/7

(57) ABSTRACT

The present invention discloses a method of information content quick access for a digital networking device. The method comprises the steps of: inputting an executing code in a terminal quick access system assembled at the digital networking device and opening an information content corresponding to the executing code by the terminal quick access system. The method further comprises the steps of: connecting the terminal quick access system to a cloud server system, acquiring an information content access website address corresponding to the executing code, connecting to the website address, and downloading an information content. The present invention further discloses an information content management system for executing the method of in formation content quick access. The information content management system comprises a cloud server system and at least one terminal quick access system.

### TECHNICAL FIELD

This invention relates to an information content management for a digital networking device, wherein the information content comprises but not limits to software, allocation program, website, and etc, and the management is defined that the information content in the digital networking device is conveniently quick access for a user.

### BACKGROUND OF THE INVENTION

With technology upgrading, a user can acquire any information content by any kind of digital networking device, such as computer, cell phone, digital TV set top box, and mobile device, when- and wherever he is. The said information content can be software, application program, website or phone dialing. In order to conveniently and quickly click frequently-used information contents for a user, the user is able to operate the physical keys or display images (so-called hot key or shortcut) to set the corresponding information content. The setting type can be one-to-one or one-to-many. By definition, the one-to-one setting type refers that one hot key (or shortcut) corresponds to one information content, and the one-to-many setting type refers that one hot key (or shortcut) corresponds to one information content list, wherein the information content list includes more than one information content. In the future, it is convenient that the information can be selected by the hot key (or shortcut) directly. The convenience may solve the problem of clicking multi-directory list, and the trouble of repeatedly typing the URL to connect to a specific website.

Although the above mentioned method provides the convenience for quickly accessing information contents in the digital networking device, there are still several problems to be solved: (1) the information content corresponding to one hot key (or shortcut) is limited and unexpandable; (2) the number of useful hot keys is limited and unexpandable; (3) a user must set the information content corresponding to the hot key by himself; (4) the means of quickly accessing information contents are different based on different types of the digital networking devices which are not in common so as to have to readapt when using new digital networking devices; (5) the objective of sharing quick access information content is not able to be achieved when the methods of quick access with different digital networking devices are not easily publicized or memorized; and (7) the means of quickly accessing information contents are limited to open the information contents stored in the digital networking device, but for the information contents not existing in the digital networking device, the passive update interfered by the user is processed through inputting website address, downloading the information content, and then setting.

### SUMMARY OF THE INVENTION

This invention provides an information content management system for digital networking device. In the implementation of the system, a user uses a terminal quick access system assembled at the digital networking device to achieve the purpose of planning management and information content quick access.

The method of information content quick access of this invention comprises the steps of inputting an executing code with a user operating interface provided by a terminal quick access system, searching an information content corresponding to the executing code in the digital networking device by the terminal quick access system, and continuing to open the information content or connecting to a cloud server system to acquire an information content access website corresponding to the executing code, connecting to the website address, and downloading the information content depending on whether the information content exists in the device or not.

The said executing code and the information content correspond to one another, that maens each information content has one unique executing code. To achieve the object of quick access, the executing code comprises but not limits to numbers, characters, strings, and the like, such that the executing code of traffic information content is able to be coded as 168, and the executing code of financing information content is able to be coded as 888.

The corresponding set of the executing code and the information content is executed by the cloud server system to prevent from the user setting troubles for using the digital networking device. And the executing code and the information content are able to be expanded.

The terminal quick access system of this invention is a cross-platform system and able to be executed by any type of networking devices. There is no readapting problem at replacing a digital networking device, and it is able to share executing code corresponding to the information content between each digital networking device.

The cloud server system is capable of regularly/irregularly updating the information content and the executing code in the terminal quick access system. The updating step is also capable of processing a updating request received by the cloud server system from the terminal quick access system.

To achieve above objectives, this invention provides a method of information content quick access for digital networking device comprising the steps of:

inputting an executing code in a terminal quick access system assembled at a digital networking device; and

opening an information content corresponding to the executing code with the terminal quick access system.

The method further comprises the steps of connecting the terminal quick access system to a cloud server system, acquiring an information content access website address corresponding to the executing code, connecting to the website address, and downloading an information content.

The present invention further discloses an information content management system for executing the method of information content quick access. The information content management system comprises a cloud server system and at least one terminal quick access system.

The present invention further encompasses a management process executed by the information content management system, wherein the management process comprises the step of:

assembling a terminal quick access system at a digital networking device;

inputting an executing code from an operating interface of the terminal quick access system;

acquiring a new information content with the digital networking device;

generating a new information content and a new executing code with the cloud server system; and

providing the information content and selecting the executing code with a content provider.

Other features or advantages of the present invention will be apparent from the following drawings and detailed description of several embodiments, and also from the appending claims

### BRIEF DESCRIPTION OF THE DRAWINGS

FIG. 1 shows a block diagram of the information content management system according to this invention.

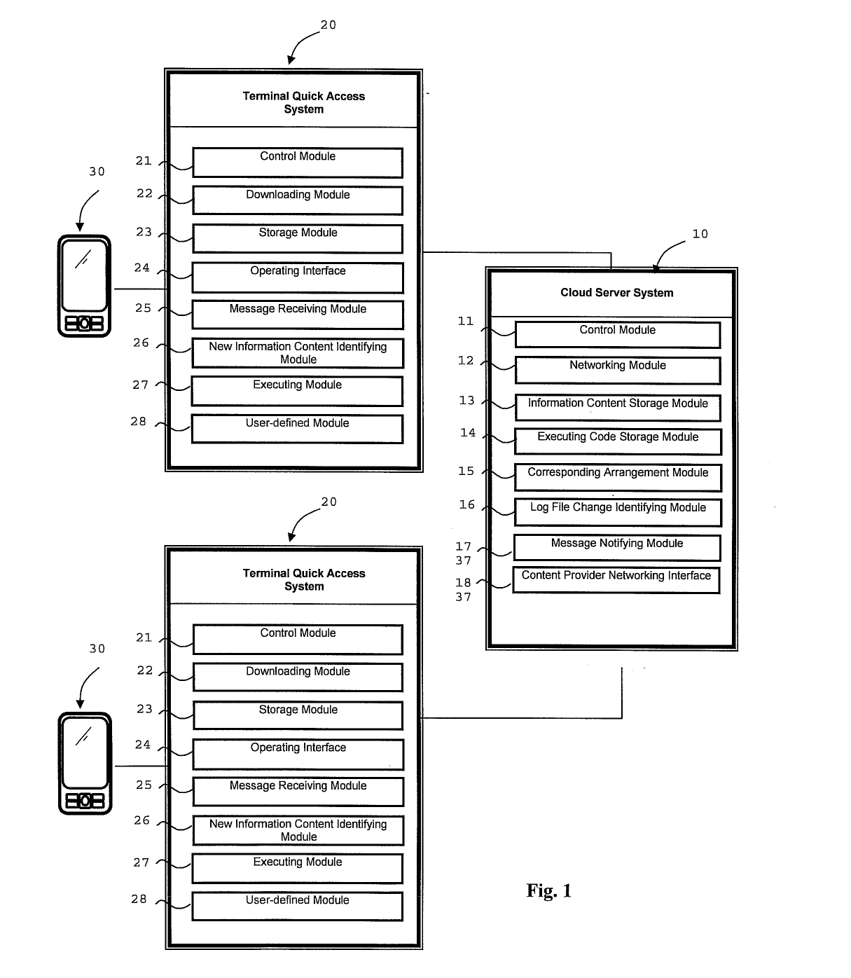

### DETAILED DESCRIPTION OF THE INVENTION

The specific examples below are to be construed as merely illustrative, and not limitative of the remainder of the disclosure in any way whatsoever. Without further elaboration, it is believed that one skilled in the art can, based on the description herein, utilize the present invention to its fullest extent. All publications cited herein are hereby incorporated by reference in their entirety. Further, any mechanism proposed below does not in any way restrict the scope of the claimed invention.

The information content management system for a digital networking device mainly comprises a cloud server system and at least one terminal quick access system 20. The terminal quick access system 20 is assembled at a digital networking device 30, so that the digital networking device 30 becomes one device with dynamic service of the cloud server system 10. The cloud server system 10 is capable of providing an executing code to the digital networking device 30 through the terminal quick access system 20. A user with the digital networking device 30 is capable of inputting the executing code to open an information content corresponding to the executing code with the quick access function of the terminal quick access system 20, or downloading an information content access website address corresponding to the executing code through the cloud server system 10, connecting to the website address, and downloading an information content. The said digital networking device 30 includes computer, cell phone, digital TV set top box, mobile device, and etc. The said information content includes software, application program, website address, executing code corresponding to the software, application program, website address, and etc.

### <Cloud Server System 10>

The cloud server system 10 comprises a control module 11, a networking module 12, an information content storage module 13, an executing code storage module 14, a corresponding arrangement module 15, a log file change identifying module 16, a message notifying module 17, and a content provider networking interface 18.

The control module 11: for commanding, controlling, ordering, and managing the following each module.

The networking module 12: for transferring and receiving files and data. The way for transferring and receiving files and data comprises Infrared Ray, Bluetooth, Internet, WiFi, WiMAX, LTE, and transmission protocol technologies of GAM, EDGE, CDMA, GPRS, UMTS, CDMA2000, TD-SCDMA, WCDMA, UMTSTDD, HSDPA, and HSUPA with 2G, 2.5G, 3G, 3.5G, and 4G.

The information content storage module 13: for storing the information content access website address provided by the content provider, wherein the said information content comprises software, program, and etc.

The executing code storage module 14: for generating, clustering, and storing the executing code, wherein the said executing code includes but not limits to numbers, characters, strings, and etc.

The corresponding arrangement module 15: for providing one unique executing code to correspond to each information content stored in the information content storage module 13, and saving with a log file, wherein the said executing code is acquired form the executing code storage module 14.

The log file change identifying module 16: for connecting with the corresponding arrangement module 15, and discriminating if a new log file is generated; if yes, a new log message is generated.

The message notifying module 17: for receiving the new message, and releasing a notification regularly/irregularly to the terminal quick access system 20 of the digital networking device 30, wherein the said notification includes but not limits to software name, program name, website name, brief description, and executing code.

The content provider networking interface 18: for providing the executing codes stored in the executing code storage module 14 with clustering to the content provider to browse and select, receiving the executing code selected by the content provider, receiving the information content access website address provided by the content provider and corresponding to the executing code, and sending the executing code selected by the content provider and the information content access website address corresponding to the executing code to the information content storage module 13 and the corresponding arrangement module 15.

### <Terminal Quick Access System 20>

The terminal quick access system 20 comprises a control module 21, a downloading module 22, a storage module 23, an operating interface 24, a message receiving module 25, a new information content identifying module 26, an executing module 27, and a user-defined module 28.

The control module 21: for commanding, controlling, ordering, and managing the following each module.

The downloading module 22: for acquiring the information content access website and executing code thereof from the cloud server system 10 with the network function of the digital networking device 30, connecting to the information content access website address, and downloading the information content corresponding to the executing code.

The storage module 23: storing the information content access website address, the information content downloaded by the downloading module 22 and the executing code thereof to a storage unit built-in the digital networking device 30.

The operating interface 24: comprising an input device and an information display graphic interface, wherein the input device comprises a physical keyboard of the digital networking device 30, or a virtual keyboard shown on a display of the digital networking device 30, and the information display graphic interface appears to the display of the digital networking device 30. A user with the digital networking device 30 is capable of inputting an executing code through the input device, and showing the input executing code and the name of the information content corresponding thereto to the information display graphic interface.

The message receiving module 25: for receiving the notification released from the cloud server system 10.

The new information content identifying module 26: for connecting to the storage module 23 and discriminating if a new information content is downloaded (whatever the new information content is acquired from the cloud server system 10 or other website addresses); if yes, a look-up executing code message is generated.

The executing module 27: for acquiring the input executing code from the operating interface, and comparing and discriminating the input executing code and the executing code stored in the storage module 23 to make sure if the input executing code exists in the storage module 23; if yes, launching the software or program corresponding to the executing code, or connecting the website address; if no, notifying the downloading module 22 through the digital networking device 30 with network function and connecting to cloud server system 10 to check if the executing code has corresponding information content access website address; if yes, downloading the executing code and the information content access website address, downloading the information content from the website address, and updating the information content of the digital networking device 30; wherein the information content update is capable of performing when the notification released from the cloud server system 10 is received by the message receiving module 25, by the means of ordering the downloading module 22 through the digital networking device 30 with network function to download the new information content access website address and the executing code thereof from the cloud server system 10.

The said information content update is also capable of performing when a new look-up executing code message is generated by the new information content identifying module 26, that is connecting the executing module 27 to the cloud server system 10, and looking up if a new information content or the downloading website address thereof exists in the information content storage module 13 of the cloud server system 10 and the executing code is assigned; if yes, further downloading the executing code corresponding to the new information content and the information content access website address thereof, and storing in the storage module 23 of the terminal quick access system 20.

The user-defined module 28: for receiving each number (0-9) set to the built-in software, program, website address, or contact person through the input device of the operating interface 24 by a user.

### <Management Process I>

In the information content management system, the steps executed by a terminal quick access system 20 arranged at a digital networking device 30 comprise:

step one: arranging the terminal quick access system 20 at the digital networking device 30; and

step two: connecting to the cloud server system 10 from the downloading module 22 of the terminal quick access system 20 through the digital networking device 30 with the network function, downloading the whole information content access website addresses and the executing codes thereof from the cloud server system 10 to the storage module 23 of the terminal quick access system 20.

### <Management Process II>

In the information content management system, the steps executed by the operating interface 24 of the terminal quick access system 20 to input an executing code comprise:

step one: executing the terminal quick access system 20 in the digital networking device 30 (whatever the digital networking device 30 is operating any function, the terminal quick access system 20 is capable of being invoked immediately);

step two: inputting an executing code form the operating interface 24 of the terminal quick access system 20;

step three: acquiring the input executing code from the operating interface 24 to the terminal quick access system 20;

step four: comparing and discriminating the executing code acquired by the terminal quick access system 20 and the executing code stored in the storage module 23 to make sure if the input executing code exists in the storage module 23; and

step five: launching the software, program, or website address connection corresponding to the executing code when making sure that the input executing code exists in the storage module 23, and acquiring the information content access website address corresponding to the executing code form the cloud server system 10 to the downloading module 22 through the digital networking device 30 with network function, connecting to the website address, and downloading the information content corresponding to the executing code.

### <Management Process III>

In the information content management system, the steps executed by discriminating if a new information content is downloaded by the digital networking device 30, such as installing a new program or creating a new bookmark, comprises:

step one: informing the new information content identifying module 26 of the terminal quick access system 20 that there is a new information content in the digital networking device 30;

step two: generating a look-up executing code message from the information content identifying module 26 and sending to the executing module 27; and

step three: connecting the executing module 27 to the cloud server system 10, searching if the new information content acquired from the digital networking device 30 exists a corresponding executing code in the cloud server system 10; if yes, downloading the executing code corresponding to the new information content from the cloud server system 10, and storing the downloaded executing code and the new information content access website address to the storage module 23 of the terminal quick access module 20; if no, ending it.

### <Management Process IV>

In the information content management system, the steps executed by generating a new information content and a new executing code form a cloud server system 10 comprises:

step one: discriminating a new log file generated, generating a new log message, and sending to the message notifying module 17;

step two: releasing a notification from the message notifying module 17 to the terminal quick access system 20 of the digital networking device 30, wherein the contents of the notification include name of the information content and the executing code;

step three: receiving the notification with the terminal quick access 20, wherein the contents of the notification include but not limit to software name, program name, website name, brief description, and executing code; and

step four: ordering the downloading module 22 from the executing module 27 of the terminal quick access system 20 through the digital networking device 30 with network function, and downloading the new information content access website address and executing code thereof from the cloud server system 10.

### <Management Process V>

In the information content management system, the steps executed by a content provider providing and selecting the executing code comprise:

step one: providing the executing code to the content provider to browse and select with clustering through the content provider networking interface 18 of the cloud server system 10;

step two: acquiring the executing code selected by the content provider to the content provider networking interface, and receiving the information content access website address provided by the content provider and corresponding to the executing code; and

step three: sending the information content access website address and the executing code of step two to the information content storage module 13 and the corresponding arrangement module 15 of the cloud server system 10.

### <Method of Information Content Quick Access>

A user with digital networking device 30 is able to open the information content corresponding to the executing code by inputting the executing code through the operating interface 24 provided by the terminal quick access system 20, or acquire the information content access website address corresponding to the executing code, connect to the website address, and download the information content.

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the claims.

What is claimed is:

1. A method of information content quick access for a digital networking device, comprising:
inputting an executing code to a terminal quick access system assembled at a digital networking device, and an information content corresponding the executing code is opened by the terminal quick access system;
wherein the method further comprising connecting the terminal quick access system to a cloud server system, retrieving an information content access website address corresponding the executing code from the cloud server system, connecting the website address, and downloading the information content.

2. An information content management system for a digital networking device, comprising:
a cloud server system and at least one terminal quick access system;
wherein the cloud server system including:
a control module, commanding, controlling, ordering, and managing each module of the cloud server system;
a networking module, transferring and receiving files and data;
an information content storage module, storing information contents;
an executing code storage module, generating and storing executing codes; and
a corresponding arrangement module, arranging a unique executing code corresponding to each information content, and saving a log file generated by the arrangement result; and
the terminal quick access system including:
a control module, commanding, controlling, ordering, and managing each module of the terminal quick access system;
a downloading module, downloading the information content access website address and the executing code from the cloud server system;
a storage module, storing the information content access website address and the executing code downloaded from the cloud server system;
an operating interface, allowing to input and display the executing code; and
a executing module, capturing the input executing code, comparing and determining the executing code if the input executing code exists in the storage module of the terminal quick access system; if yes, opening the information corresponding to the executing code; if not, retrieving the information content access website address corresponding to the executing code, connecting to the website address, and downloading the information content.

3. The management system of claim 2, wherein
the cloud server system further comprises:
a log file change identifying module, connected with the corresponding arrangement module, and discriminating if a new log file is produced; if yes, generating a new log message; and
a message notifying module, receiving the new log message and releasing a notification to terminal quick access system through the networking module, and a content of the notification including a name of the information content and the executing code; and
the terminal quick access system further comprises:
a message receiving module, receiving the notification, connecting the terminal quick access system and the cloud server system, and downloading a new information content access website address and the executing code corresponding thereto.

4. The management system of claim 3, wherein the cloud server system further comprises a content provider networking interface for executing the steps of:
clustering the whole executing codes of the storage module and providing a content provider to browse;
receiving the executing code selected by the content provider;
receiving the information content or the information content access website address corresponding to the executing code provided by the content provider; and
sending the selected executing code and the corresponding information content or the information content access website address to the information content storage module and the corresponding arrangement module.

5. The management system of claim 3, wherein the terminal quick access system further comprises a new information content identifying module, connected with the storage module and discriminating if a new information content is downloaded by the digital networking device, wherein the new information content at least includes a new installed program or a new created bookmark; and
when the new information content is generated, the executing module connects the cloud server system to look up the new information content if the corresponding executing code exists in the information content storage module of the cloud server system; if yes, the executing code corresponding to the new information content is downloaded by the downloading module of the terminal quick access system, and stored to the storage module of the terminal quick access module, so as to use the new information content with the executing code in the digital networking device.

6. An information content management process of a digital networking device, comprising a management process executed by an information content system including a digital networking device and a terminal quick access system installed thereto, wherein the management process comprises downloading the whole information content access website addresses and the executing codes corresponding thereto with the terminal quick access system to the storage module of the terminal quick access system.

7. The information content management process of claim 6, further comprises a management process executed by an operating interface of the terminal quick access system to input an executing code, comprising:
capturing an executing code input by the a user in the operating module of the terminal quick access module; and
comparing and determining the acquired executing code and the executing code in the storage module to make sure if the input executing code exists in the storage module; if yes, opening the information content corresponding to the executing code; if no, retrieving the information content access website address corresponding to the executing code, connecting to the website address, downloading the information content, and opening the information content.

8. The information content management process of claim 6, further comprises a management process executed by the digital networking device to acquire a new information content without storing a corresponding executing code in the storage module of the terminal quick access system, the process comprising:
connecting the terminal quick access system to the cloud server system, and looking up if the executing code corresponding to the new information content exists in the information content storage module of the cloud server system; if yes, downloading the executing code corresponding to the new information content from the cloud server system to the terminal quick access system.

9. The information content management process of claim 6, further comprises a management process executed by the cloud server system to generate a new information content access website address and a new executing code, comprising:
notifying the generated new information content access website address and the new executing code from the cloud server system to the terminal quick access system; and
downloading the new information content access website address and the executing code from the cloud server system to the terminal quick access system.
